(19) United States
(12) Patent Application Publication
(10) Pub. No.: US 2014/0239876 A1
(43) Pub. Date: Aug. 28, 2014

(54) ELECTRIC DRIVE WITH RECONFIGURABLE WINDING

(71) Applicant: GM GLOBAL TECHNOLOGY OPERATIONS LLC, Detroit, MI (US)

(72) Inventors: Lei Hao, Troy, MI (US); Chandra S. Namuduri, Troy, MI (US)

(73) Assignee: GM GLOBAL TECHNOLOGY OPERATIONS LLC, DETROIT, MI (US)

(21) Appl. No.: 13/777,572

(22) Filed: Feb. 26, 2013

(51) Int. Cl. H02P 25/18

(52) U.S. Cl. CPC H02P 25/188
USPC 318/724

(57) ABSTRACT

An electric drive system for a PM electric machine, where the machine includes a stator, a rotor and an inverter. Each phase of the machine includes a stator winding separated into a first winding section and a second winding section and two switches in the inverter electrically coupled to the winding sections. The drive system includes a switch assembly for each phase electrically coupled to the inverter switches and the first and second winding sections, where the switch assembly includes at least two switch states. A first switch state of the switch assembly electrically couples the first winding section and the second winding section in series to the inverter switches and a second switch state electrically couples the second winding section to the inverter switches and electrically disconnects the first winding section from the inverter switches.

### BACKGROUND OF THE INVENTION

1. Field of the Invention

This invention relates generally to an electric machine and, more particularly, to a permanent magnet (PM) AC electric machine including a drive system that electrically reconfigures split stator windings at a predetermined machine speed to reduce back EMF and increase the torque and power of the machine at higher machine speeds.

2. Discussion of the Related Art

An electric machine having a wide speed range is essential for automotive propulsion systems, such as for hybrid vehicles, electric vehicles, fuel cell vehicles, etc., and for power generation applications. In order to maximize its torque/ampere ratio, the electric machine is typically designed to have as high of an induced voltage-to-speed ratio as possible. However, because the induced voltage is proportional, especially as the speed of the machine increases, the back electro-motive force (EMF) generated by the machine also increases as the machine speed increases until it reaches the DC bus voltage, generally a battery voltage, which results in a loss of EMF available to drive the current in the motor, which acts to limit the speed of the machine.

To overcome this problem, it has been proposed in the art to increase the speed of the machine by injecting a demagnetization current into the machine stator windings, referred to in the art as flux weakening, which reduces the back EMF of the machine so that the speed of the machine can be increased. Other techniques are known in the art for winding reconfiguration to reduce the back EMF of an electric machine and extend the operating speed range of the machine by reconfiguring the number of turns of machine phase windings.

In one known winding reconfiguration approach, the stator windings for each phase of the machine are separated into two split windings. Switches are provided and are controlled so that the split windings for each phase are electrically coupled in series for low machine speeds and are electrically coupled in parallel when the speed of the machine reaches the point where the back EMF reduces the machine torque. However, by providing twice as many windings in the stator and the switches necessary to switch between an electrical series configuration and a parallel configuration, this solution for winding reconfiguration increases the number of required AC switches to nine and the total number of machine leads to ten for a three-phase machine. Further, there is the potential for circulating currents in the parallel configuration due to coil EMF mismatches. Also, coils are required to be in the same stator slot for parallel operation, and lower coil inductance in the parallel operation may need higher switching frequencies to reduce current ripple.

Another known approach for reconfiguring the windings to reduce back EMF of an electric machine includes changing the pole number of the machine and switching the number of series turns per phase of the stator windings when the back EMF reaches a predetermined value. However, this approach is only useful for induction machines and is not applicable to permanent magnet (PM) machines because of the fixed number of poles in a PM machine.

Another known approach for reconfiguring the windings to reduce back EMF of an electric machine includes providing machine scalability as discussed in U.S. Patent Application Publication No. 2012/0306424, filed Jun. 2, 2011, titled, Electric Drive with Electronically Scalable Reconfigurable Winding, assigned to the assignee of this application and herein incorporated by reference. However, this approach requires nine leads and twelve AC switches for a three-phase machine. Further, the winding turn ratio versus the machine performance is not addressed.

Another approach known in the art to reconfigure the windings to reduce back EMF of an electric machine is referred to as a Y-Δ winding where the electrical connection of the stator windings is put in the traditional Y-configuration when the back EMF is low and is switched to the traditional delta (Δ) configuration when the machine back EMF starts reducing the torque of the machine. This approach has been somewhat effective for extending speed range, but has not been overly effective and has a number of drawbacks, including circulating harmonics occurring in the delta configuration, potentially increased winding saturation and limited speed range extension.

### SUMMARY OF THE INVENTION

In accordance with the teachings of the present invention, an electric drive system for a PM electric machine is disclosed, where the machine includes a stator, a rotor and an inverter. Each phase of the machine includes a stator winding separated into a first winding section and a second winding section and two inverter switches in the inverter electrically coupled to the winding sections. The drive system includes a switch assembly for each phase electrically coupled to the inverter switches and the first and second winding sections, where the switch assembly includes at least two switch states. A first switch state of the switch assembly electrical couples the first winding section and the second winding section in series to the inverter switches and a second switch state electrically couples the second winding section to the inverter switches and electrically disconnects the first winding section from the inverter switches.

Additional features of the present invention will become apparent from the following description and appended claims, taken in conjunction with the accompanying drawings.

### BRIEF DESCRIPTION OF THE DRAWINGS

FIG. 1 is a schematic diagram of a traditional PM electric machine;

FIG. 2 is a quarter section view of a PM electric machine including a stator and a rotor;

FIG. 3 is a schematic diagram of a reconfigurable winding electric drive system for one phase of a PM electric machine;

FIG. 4 is a graph with speed on the horizontal axis, torque on the left vertical axis and power on the right vertical axis showing a relationship between machine speed and torque and machine speed and power for a drive system of a PM electric machine in a power boost mode;

FIG. 5 is a graph with speed on the horizontal axis, torque on the left vertical axis and power on the right vertical axis showing a relationship between machine speed and torque and machine speed and power for a drive system of a PM electric machine in a higher part load efficiency mode;

FIG. 6 is a schematic diagram of an electric drive system for a PM electric machine that employs thyristor switches;

FIG. 7 is a schematic diagram of an electric drive system for a PM electric machine that employs reverse blocking IGBT switches;

FIG. 8 is a schematic diagram of an electric drive system for a PM machine that employs triac switches; and

FIG. 9 is a schematic diagram of an electric drive system for a PM machine that employs SPDT relays.

### DETAILED DESCRIPTION OF THE EMBODIMENTS

The following discussion of the embodiments of the invention directed to an electric drive system for a PM electric machine is merely exemplary in nature, and is in no way intended to limit the invention or its applications or uses. For example, the drive system of the invention has particular application for a PM electric machine on a vehicle. However, as well be appreciated by those skilled in the art, the drive system of the invention will have application for other machines.

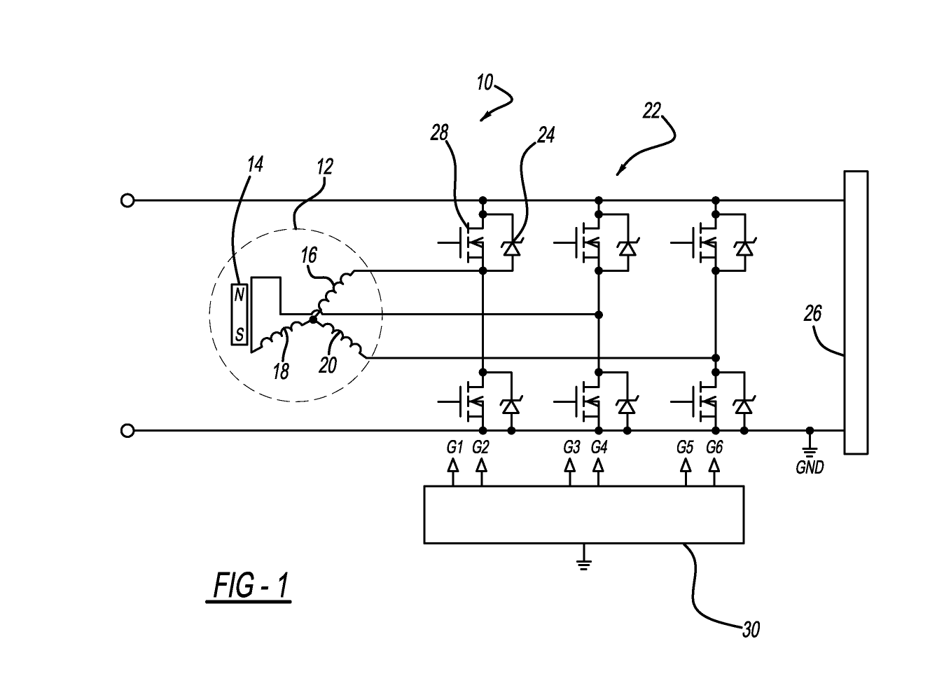

FIG. 1 is a schematic diagram of a PM electric machine system 10 including a three-phase PM electric machine 12 having a permanent magnet 14 in the rotor of the machine 12 and windings 16, 18 and 20 in the stator of the machine 12. The interaction of the magnetic flux between the permanent magnet 14 with the current flow in the windings 16-20 produces the torque that drives the machine 12. The system 10 also includes an inverter/rectifier circuit 22 having a plurality of diodes 24 that rectify the AC current generated by the windings 16-20 to a DC current to charge a vehicle battery 26. The circuit 22 also converts the DC current from the battery 26 to an AC current when the machine 12 is operating as an a motor to, for example, start the vehicle. The inverter/rectifier circuit 22 includes a plurality of MOSFET or IGBT switches 28 that are selectively switched on and off to provide the DC-to-AC inversion and rectification. A controller 30 provides control signals G1-G6 that switch the switches 28 on and off to provide the desired DC-to-AC inversion or AC-to-DC conversion in a manner well understood by those skilled in the art.

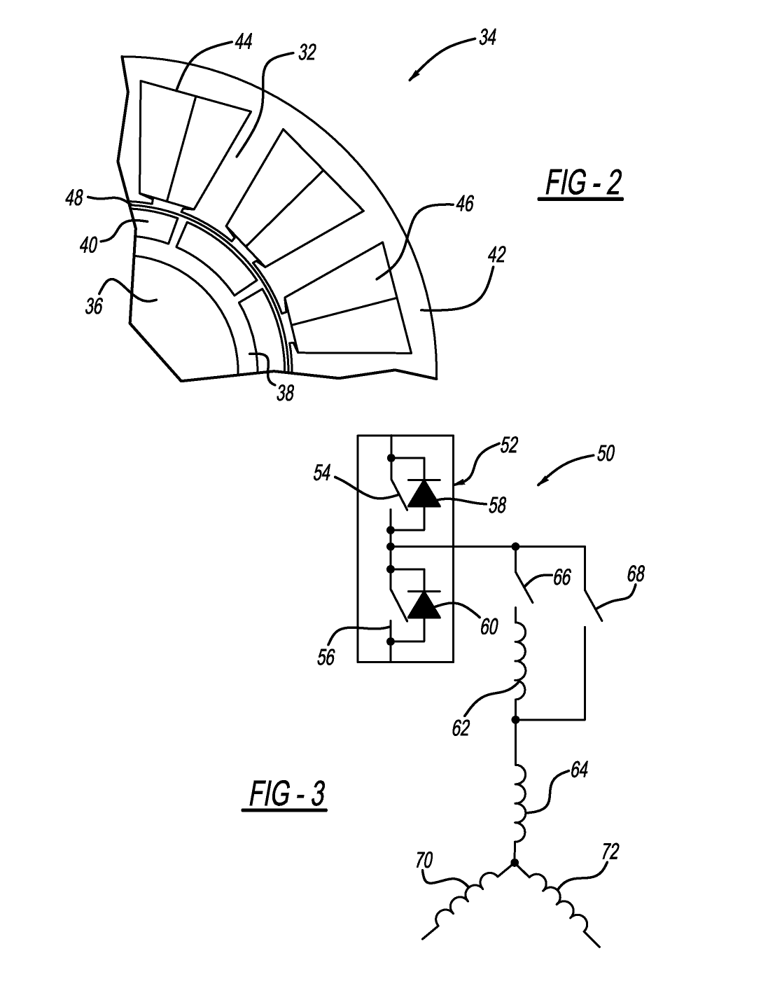

FIG. 2 is a broken-away quarter section end view of a conventional PM electric machine 34. The electric machine 34 includes a center shaft 36 surrounded by and mounted to a cylindrical rotor 38. The rotor 38 includes a plurality of permanent magnets 40 disposed around an outer perimeter of the rotor 38. The machine 34 also includes a cylindrical stator 42, having stator teeth 32 defining slots 44 therebetween, where windings 46 are wound around the teeth 32 through the slots 44. An air gap 48 separates the rotor 38 from the stator 42 and allows it to rotate relative thereto.

As is well understood by those skilled in the art, an alternating current at the proper phase is provided to the stator windings 46 so that the magnetic field generated by the current flowing through the windings 46 interacts with the magnetic field generated by the permanent magnets 40 in a manner that causes the rotor 38 to rotate relative to the stator 42, and thus causes the shaft 36 to rotate performing physical work. A flux path around the windings 46 passes through the rotor 36, the permanent magnet 40, the air gap 48 and the stator 42 to form a closed loop path and link the stator windings 46. The induced voltage of the stator 42 is proportional to the total flux linking the stator windings 46.

FIG. 3 is a schematic diagram of an electric drive system 50 for an AC permanent magnet machine that includes a half H-bridge 52 having switches 54 and 56 and diodes 58 and 60 electrically coupled as shown. The half H-bridge 52 is for one phase of the machine, i.e., for one of the windings 16, 18 or 20, where the switches 54 and 56 represent two of the switches 28 and the diodes 58 and 60 represent two of the diodes 24 in the inverter circuit 22. In the drive system 50, one of the windings 16, 18 or 20 is separated into two winding sections shown as winding section 62 and winding section 64. Winding 70 is the winding for another phase of the PM machine and would also be separated into two separate winding sections. Likewise, winding 72 is the winding for the third phase of the machine and would also be separated into two winding sections. As would be understood by those skilled in the art, other PM machines may include more phases and would have additional windings accordingly. A bidirectional switch 66 is electrically coupled in series with the winding section 62 and a bidirectional switch 68 is electrically coupled in parallel with the winding section 62. Both of the switches 66 and 68 are also electrically coupled to the half H-bridge 52 between the switches 54 and 56, as shown. Each phase of the machine would include two switches for the windings 70 and 72 in the same manner.

In this electrical configuration, when the switch 66 is closed and the switch 68 is open, current travels through the winding sections 62 and 64 in series. When the switch 66 is open and the switch 68 is closed, current only travels through the winding section 64 and not the winding section 62. In operation, for a full flux mode 1 the switch 66 is closed and the switch 68 is open at low machine speeds where high torque is required, and when the machine is required to maintain or increase the power, the switch 66 is opened and the switch 68 is closed for a reduced flux mode 2 operation at high speed. In one embodiment, the switches 66 and 68 are opened and closed when the machine reaches a predetermined speed and the current for the particular phase crosses zero to allow natural commutation of the switches 66 and 68 and minimize voltage and torque transients. In other words, when the predetermined machine speed is reached where the control switches from the full flux mode 1 to the reduced flux mode 2, the switches 66 and 68 are not all switched for each machine phase at the same time, but the switches 66 and 68 for each phase are switched when the alternating current (AC) for the particular phase is essentially at zero current.

Based on this electrical configuration of the drive system 50, back EMF reduction is provided by reducing the number of stator winding turns in the machine phase which reduces the magnetic flux when the back EMF is significant enough to reduce machine speed by reducing the current flow through the stator windings. The winding turn ratio between the winding sections 62 and 64 can be selectively designed so that the reduction in magnetic flux when the control switches from the full flux mode 1 to the reduced flux mode 2 can be accurately controlled. By providing the separate split winding sections for each phase of the three-phase machine, the extra hardware required is six additional switches and three additional wire leads beyond that of the conventional PM machine drive system design without split stator winding sections.

In one non-limiting embodiment, the ratio of the turns in the winding section 64 to the turns in the winding section 62 is in the range of 0.3 to 3. The turns ratio can be selectively controlled for two separate embodiments of the drive system 50, namely, a power boost mode that provides more power at higher machine speeds and a higher part load efficiency mode that provides a higher inverter efficiency. In the power boost mode, the ratio of the turns in the winding section 64 to the turns in the winding section 62 is less than 1, and preferably in the range of 0.3 to 1. Further, the switches 66 and 68 can have a low voltage rating, for example, less than 800 volts, and preferably 600-650 volts. The power boost mode allows the switches 66 and 68 to have a lower conduction and switching losses due to a lower voltage rating. Further, the power boost mode provides an increase of torque/power and a reduced copper loss in the higher machine speed range due to a reduced number of series turns of the winding sections 62 and 64.

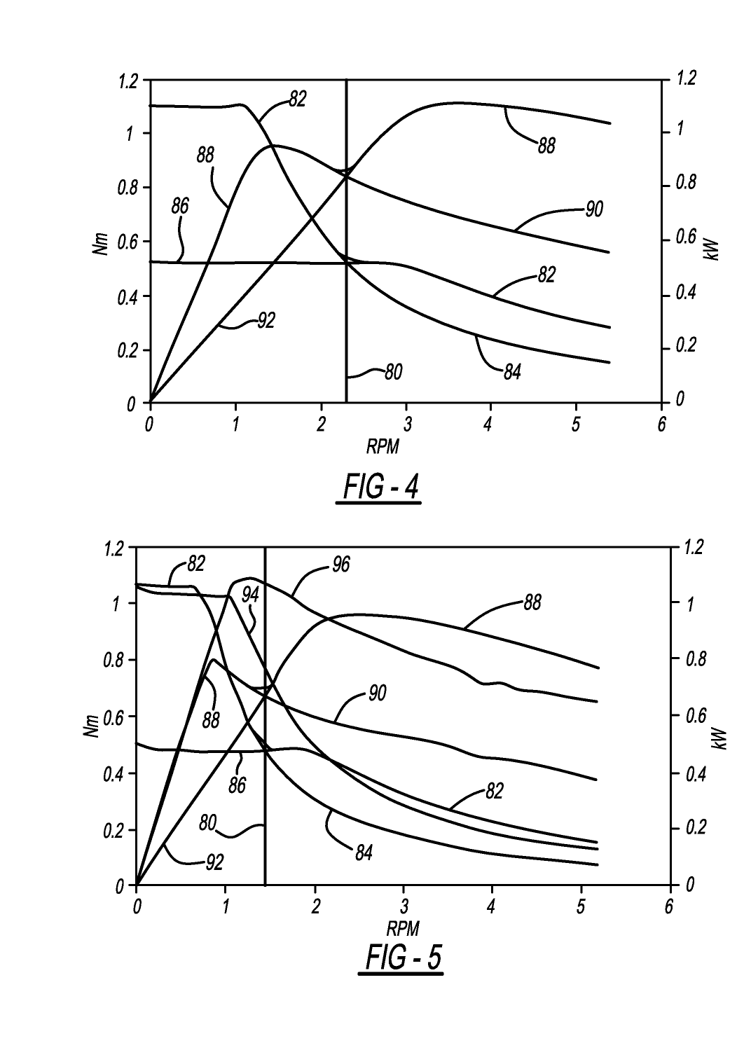

FIG. 4 is a graph with machine speed (RPM) on the horizontal axis, machine torque (Nm) on the left vertical axis and machine power (kW) on the right vertical axis showing performance for an interior PM electric machine drive system, such as the drive system 50, operating in the power boost mode and having a turn ratio between the winding sections 62 and 64 of 1. Line 80 represents the predetermined machine speed such as 5000 RPMs, where the control switches from the full flux mode 1, where the switch 66 is closed and the switch 68 is open, to the reduced flux mode 2, where the switch 66 is open and the switch 68 is closed to provide reduced flux at higher machine speeds as discussed above. Graph line 82 represents the torque of the drive system 50 where a machine operates in the full flux mode 1 before line 80 and in the reduced flux mode 2 after line 80. Graph line 84 shows what the torque of the machine would be if the machine operates only in the full flux mode 1 beyond the line 80 and graph line 86 represents what the torque of the machine would be if the machine was always in the reduced flux mode 2. Likewise, graph line 88 represents the power of the machine when the switches 66 and 68 are switched from the mode 1 to the mode 2 at the machine speed represented by the line 80. Graph line 90 represents the power of the machine if the switch 66 is kept closed at the line 80 and the machine does not enter the mode 2, and graph line 92 represents the power of the machine if the machine is always in the mode 2.

In the higher part load efficiency mode, the ratio of the turns in the winding section 64 to the turns in the winding section 62 is greater than 1, and preferably in the range of 1-3. The part load efficiency is improved by providing more turns per phase of machine than a conventional machine without winding reconfiguration and also more turns in the winding section 64 than in the winding section 62 so that less phase currents are required to generate same torque. In the part load efficiency mode, the drive system switches from the mode 1 to the mode 2 at a lower machine speed than in the power mode. For example, for the same number of total turns of the winding sections 62 and 64, the drive system 50 may switch from the full flux mode 1 to the reduced flux mode 2 at about 3500 RPMs. In this embodiment, the switches 66 and 68 have a lower current rating, preferably less than 70% of that in a comparable conventional inverter without winding reconfiguration. The higher part load efficiency mode provides improved inverter efficiency at part load condition and reduced copper loss at high speed operation.

FIG. 5 is a graph similar to the graph in FIG. 4 where like graph lines are identified by the same reference numeral and including a base line torque and a base line power. In this example, the ratio of the turns in the winding section 64 to the turns in the winding section 62 is 1.333. For the part load efficiency mode, the switch from the mode 1 to the mode 2 occurs at a lower machine speed, for example, about 3500 RPMs at the line 80. In addition, graph line 94 represents a base line torque and graph line 96 represents a base line power.

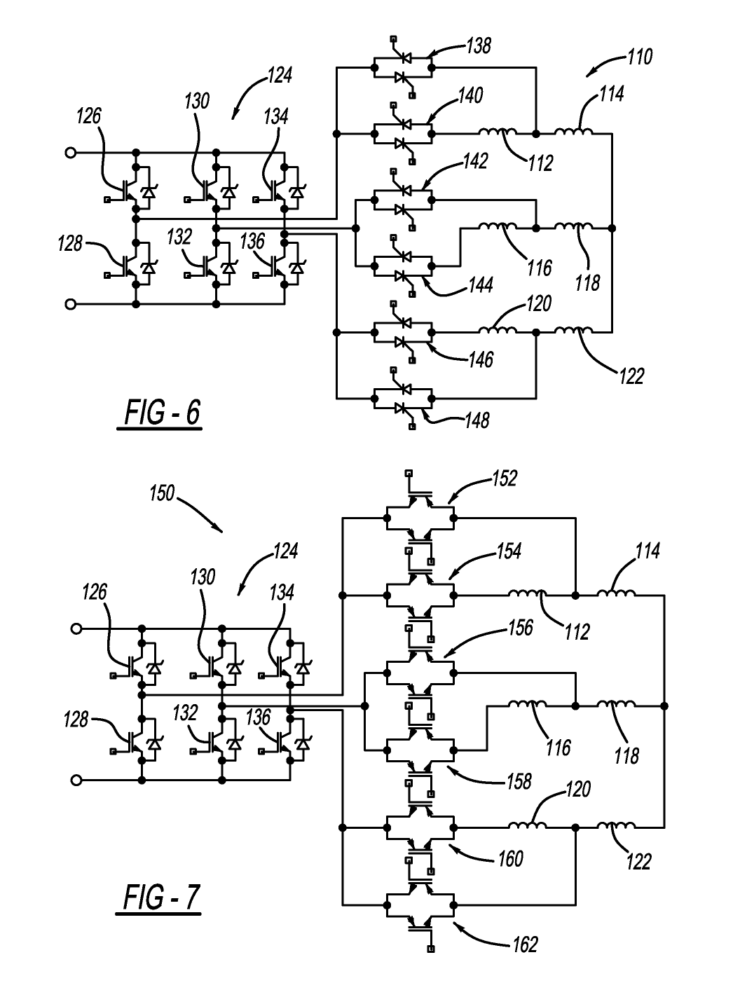

The switches 66 and 68 can be any AC voltage blocking switches suitable for the purposes discussed herein depending on the desired performance and specific application of the machine. FIG. 6 is a schematic diagram of a drive system 110 for an AC permanent magnet electric machine that shows all three phases of the machine. The split stator windings are shown as winding sections 112 and 114 for the first phase, winding sections 116 and 118 for the second phase, and winding sections 120 and 122 for the third phase. The drive system 110 includes an inverter circuit 120 having switches 126 and 128 for the first phase, switches 130 and 132 for the second phase and switches 134 and 136 for the third phase. The anti-parallel diodes with the inverter switches are not shown for simplicity, but are integral to the inverter as shown in FIG. 1. In this embodiment, the winding switches are thyristors each including two thyristors, particularly, thyristors 138 and 140 for the first phase, thyristors 142 and 144 for the second phase, and thyristors 146 and 148 for the third phase. The thyristors provide a low switch on voltage, for example, 1-1.5 volts, are very rugged, provide high overload capability, and have a less than 10 ms switching time.

FIG. 7 is a schematic diagram of a drive system 150 similar to the drive system 110 where like elements are identified by the same reference numeral. In this embodiment, the thyristors are replaced with reverse blocking insulated gate bipolar transistors (RB-IGBT) having opposing transistor switches, namely, RB-IGBTs 152 and 154 for the first phase, RB-IGBTs 156 and 158 for the second phase, and RB-IGBTs 160 and 162 for the third phase. The RB-IGBTs provide a simple gate drive with less than a 5 ms switching time.

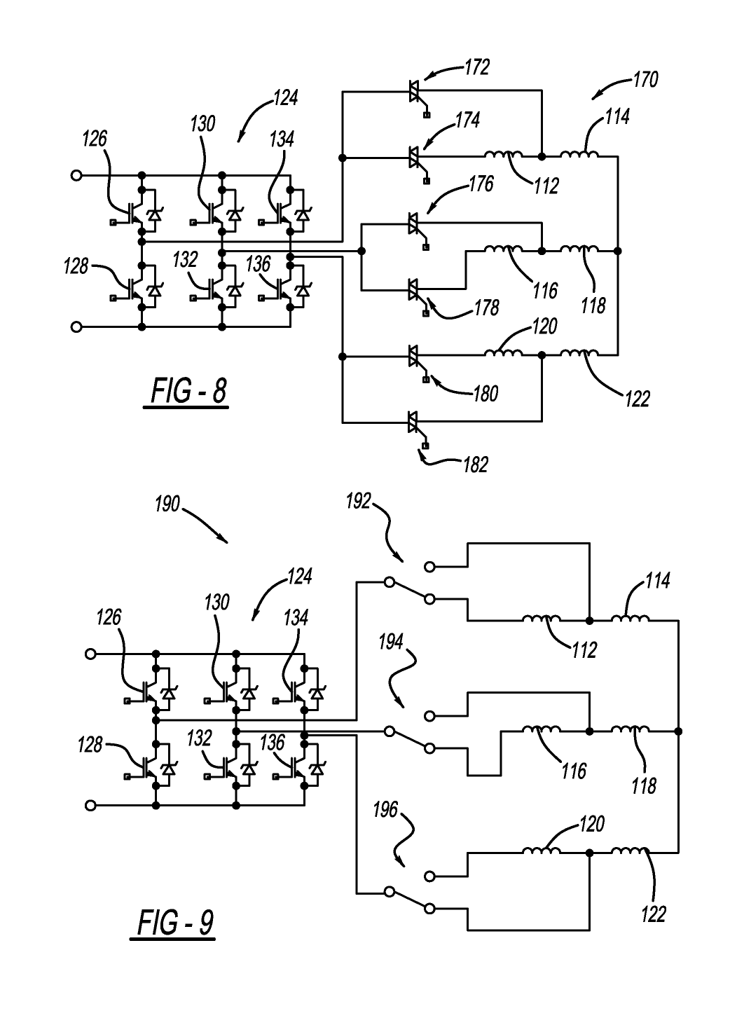

FIG. 8 is a schematic diagram of a drive system 170 similar to the drive system 110, where like elements are identified by the same reference number. In this embodiment, the thyristors are replaced with triacs, namely, triacs 172 and 174 for the first phase, triacs 176 and 178 for the second phase, and triacs 180 and 182 for the third phase. Triacs provide a low switch on voltage, such as 1-1.5 volts, simple packaging, high overload capabilities, and a less than 10 ms switching time.

FIG. 9 is a schematic diagram of a drive system 190 similar to the drive system 110, where like elements are identified by the same reference number. In this embodiment, the thyristors are replaced with SPDT relays, namely, relay 192 for first phase, relay 194 for the second phase and relay 196 for the third phase. The relays provide a low on voltage, such as less than 1 volt, and no requirement for additional heat sinking, but are bulky and have a longer switching time.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A drive system for a permanent magnet (PM) electric machine, said machine including a stator, a rotor and an inverter, said drive system comprising:
at least one stator winding in the stator including a first winding section and a second winding section;
at least two inverter switches in the inverter electrically coupled to the first and second winding sections; and
a switch assembly electrically coupled to the inverter switches and the first and second winding sections, said switch assembly including at least two switch states where a first switch state electrical couples the first winding section and the second winding section in series to the inverter switches and a second switch state electrically couples the second winding section to the inverter switches and electrically disconnects the first winding section from the inverter switches.

2. The drive system according to claim 1 wherein the PM machine is a multi-phase machine where each phase includes a stator winding having first and second winding sections, two inverter switches and a switch assembly having a first state where both the first and second winding sections are electrically coupled to the inverter switches and a second state where only the second winding section is electrically coupled to the inverter switches.

3. The drive system according to claim 1 wherein the at least one switch assembly includes first and second thyristors.

4. The drive system according to claim 1 wherein the at least one switch assembly includes first and second reverse blocking insulated gate bipolar transistors.

5. The drive system according to claim 1 wherein the at least one switch assembly includes a first triac and a second triac.

6. The drive system according to claim 1 wherein the at least one switch assembly is an SPDT relay.

7. The drive system according to claim 1 wherein the ratio of turns in the second winding section to the turns in the first winding section is less than 1.

8. The drive system according to claim 7 wherein the ratio of the turns in the second winding section to the turns in the first winding section is between 0.3 and 1.

9. The drive system according to claim 1 wherein the ratio of turns in the second winding section to the turns in the first winding section is greater than 1.

10. The drive system according to claim 9 wherein the ratio of the turns in the second winding section to the turns in the first winding section is between 1 and 3.

11. A drive system for a multi-phase permanent magnet (PM) electric machine, said machine including a stator, a rotor and an inverter, said drive system comprising:
a stator winding in each phase of the PM electric machine where each stator winding includes a first winding section and a second winding section;
two inverter switches in the inverter for each phase of the PM electric machine where the two inverter switches for each phase are coupled to the first and second winding sections for that phase in the stator; and
a switch assembly for each phase of the PM electric machine, each switch assembly being electrically coupled to the inverter switches and the first and second winding sections for that phase, said switch assembly including at least two switch states where a first switch state electrically couples the first winding section and the second winding section in series to the inverter switches and a second switch state electrically couples the second winding section to the inverter switches and electrically disconnects the first winding section from the inverter switches.

12. The drive system according to claim 11 wherein the switch assemblies include switches selected from the group consisting of thyristors, triacs, reverse blocking inverse gate bipolar transistors and relays.

13. The drive system according to claim 11 wherein the ratio of the turns in each second winding section to the turns in each first winding section is between 0.3 and 1.

14. The drive system according to claim 11 wherein the ratio of the turns in each second winding section to the turns in each first winding section is between 1 and 3.

15. A drive system for a multi-phase permanent magnet (PM) electric machine, said machine including a stator, a rotor and an inverter, said drive system comprising:
a stator winding in each phase of the PM electric machine where each stator winding includes a first winding section and a second winding section;
two inverter switches in the inverter for each phase of the PM electric machine where the two inverter switches for each phase are coupled to the first and second winding sections for that phase in the stator; and
a first switch and a second switch for each phase of the PM electric machine, each first and second switch being electrically coupled to the inverter switches and the first and second winding sections for that phase, wherein when the first switch is closed and the second switch is open the first winding section and the second winding section for the phase are electrically coupled in series to the inverter switches and when the first switch is open and the second switch is closed the second winding section is electrically coupled to the inverter switches and the first winding section is electrically disconnected from the inverter switches.

16. The drive system according to claim 15 wherein the first and second switches are selected from the group consisting of thyristors, triacs, reverse blocking inverse gate bipolar transistors and relays.

17. The drive system according to claim 15 wherein the ratio of turns in each second winding section to the turns in each first winding section is less than 1.

18. The drive system according to claim 17 wherein the ratio of the turns in each second winding section to the turns in each first winding section is between 0.3 and 1.

19. The drive system according to claim 15 wherein the ratio of turns in each second winding section to the turns in each first winding section is greater than 1.

20. The drive system according to claim 19 wherein the ratio of the turns in each second winding section to the turns in each first winding section is between 1 and 3.
